(19) United States
(12) Patent Application Publication
(10) Pub. No.: US 2009/0146068 A1
(43) Pub. Date: Jun. 11, 2009

(54) RADIATION DOSIMETER

(75) Inventor: Prabhat Agarwal, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,550

(22) PCT Filed: Nov. 17, 2005
(86) PCT No.: PCT/IB05/53805

§ 371 Date: May 17, 2007

(30) Foreign Application Priority Data
Nov. 23, 2004 (EP) 04105989.0

(51) Int. Cl. G01T 1/24

(52) U.S. Cl. 250/370.07

(57) ABSTRACT

A personal X-ray dosimeter system, comprising a portable detector (100) and a reader device (114). The portable detector (100) comprises an array (104) of programmed non-volatile memory elements (102) and a scintillator element (106) for converting a portion of X-radiation incident thereon to UV radiation. As a result of exposure to X-radiation (112) not converted to UV radiation, some of the memory elements (102) will have the charge on their floating gates, thereby causing a corresponding shift in threshold voltage (VT). After some exposure time, the reader device (114) reads from the detector (100) data representative of the number of VT shifted memory elements (102), and determines therefrom using predetermined calibration curves, the radiation dose (122) to which the user has been exposed.

This invention relates generally to a radiation dosimeter and, more particularly, to a method and device for determining a level of radiation to which a user has been exposed.

Electronic personal dosimeters are used by personnel in potentially hazardous environments. An example of such an environment might be a medical environment, in which there is the possibility that radiographers and related personnel might be exposed to doses of X-rays that may be potentially hazardous to their health. For this reason, such personnel are often required to wear or otherwise carry an electronic personal dosimeter which operates to detect radiation and provides an indication of an amount of radiation to which the personnel have been exposed over a period of time.

Devices are known in which X-rays are detected due to the chemical changes their energy causes in a photographic plate. However, such devices do not necessarily have a sufficiently long lifespan or capability for effective and repeated re-use.

U.S. Pat. No. 5,596,199 describes a microdosimetry detector device comprising an array of non-volatile memory devices capable of storing a predetermined initial charge without requiring a power source. Each radiation particle incident on a non-volatile memory device generates a charge within a sensitive volume of the device and alters the stored initial charge by some amount corresponding to the energy deposited by certain types of radiation particle. Data corresponding to such charge alterations in respect of the non-volatile memory devices within the array is input to a qualitative analysing device, which converts such data to a spectral analysis of the incident radiation field. Thus, the described device is capable, not only of detecting the exposure of the user to radiation, but also of characterising such exposure in terms of dose equivalent or similar measurement capable of describing the propensity of incident radiation to damage a user's health.

However, not only does the above-mentioned device fail to discriminate between radiation types during the detection stage of operation, but it also requires a rather complex analysis process to determine the level of exposure and the potential hazard posed by such exposure.

It is an object of the present invention to provide a device and method for determining a level of radiation to which a user has been exposed, which is less complex, in both its configuration and operation, compared with prior art arrangements, and gives a quick, accurate indication of exposure by the user to one or more hazardous radiation types.

In accordance with the present invention, there is provided a detector for determining a level of radiation to which a user has been exposed, the device comprising a plurality of non-volatile memory elements, means for enabling said memory elements to be programmed by forming a charge at a floating gate thereof, means for enabling the number of said memory elements which have undergone a shift in threshold voltage as a result of exposure to radiation to be determined so as to enable determination therefrom the radiation dose to which said user has been exposed.

Also in accordance with the present invention, there is provided a reader device for use with the detector defined above, the reader device comprising means for connecting said reader device to said detector and receiving data therefrom representative of the number of memory elements which have undergone a shift in threshold voltage as a result of exposure to radiation, comparing said data with predetermined calibration data and determining thereby a radiation dose to which a user has been exposed.

The present invention extends to a dosimeter system comprising the detector and reader device as defined above.

Still further in accordance with the present invention, there is provided a method of determining a level of radiation to which a user has been exposed, the method comprising providing a user with a detector as defined above, obtaining data therefrom representative of the number of memory elements which have undergone a shift in threshold voltage as a result of exposure to radiation, comparing said data with predetermined calibration data and determining thereby a radiation dose to which a user has been exposed.

In a preferred embodiment of the invention, the detector may comprise a scintillator element, such as doped NaI or more advanced materials which will be apparent to a person skilled in the art, for “capturing” some incident radiation and converting it to UV radiation. Thus, in the case of a detector for an X-ray dosimeter system, the scintillator element (which may be provided in the form of a cover for the memory elements or a screen) “captures” some of the x-radiation (and higher frequency photons) incident thereon and converts it to UV radiation. In a simpler version of the invention, where no scintillator element is provided, the X-ray dose and the required floating gate volume is large, so that a significant amount of X-rays interact with the floating gates, generate charge and cause corresponding threshold voltage shifts. In this case, a filter element may be provided for permitting only radiation of a certain type (or above a predetermined frequency) to reach the non-volatile memory elements. Specifically, this filter may comprise a UV filter for blocking UV radiation and permitting radiation of a higher frequency (specifically X-radiation) to pass to the non-volatile memory elements. However, with the provision of the scintillator element, a lower proportion of X-rays interact with the floating gate memory elements, so that a smaller floating gate volume can be provided and the overall detector can be made smaller, less complex and less expensive.

In one exemplary embodiment of the present invention, the non-volatile memory elements may be provided in the form of an array, for ease of manufacture and optimisation of integrated circuit die space.

The reader device preferably comprises means for programming the non-volatile memory elements, thereby eliminating the need for any additional hardware in this regard. The detector device preferably comprises an interface for enabling the reader to be coupled thereto, for hard-wired or wireless communication therewith. In a preferred embodiment, the reader device is arranged and configured to read data from said detector device representative of a number of memory elements in respect of which the threshold voltage has been shifted as a result of exposure to radiation. The calibration data beneficially comprises predetermined calibration curves.

A portion of the memory array may be used to store data, such as user data in relation to a predetermined one or more users and/or time stamps indicative of one or more previous read-out operations.

These and other aspects of the present invention will be apparent from, and elucidated with reference to, the embodiments described herein.

Embodiments of the present invention will now be described by way of examples only and with reference to the accompanying drawings, in which:

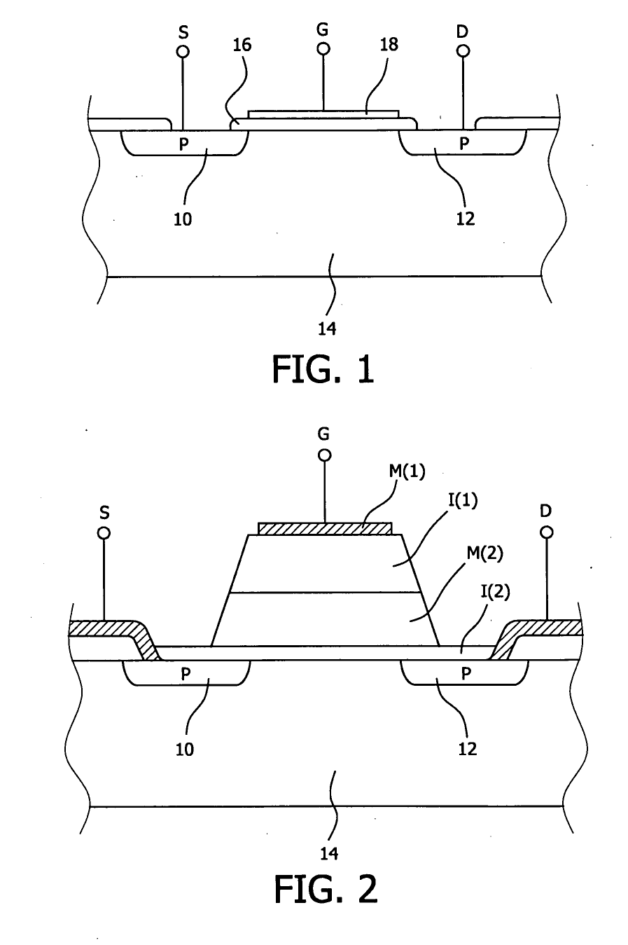

FIG. 1 is a schematic cross-sectional view of the structure of a conventional IGFET device;

FIG. 2 is a schematic cross-sectional view of the structure of a floating gate device;

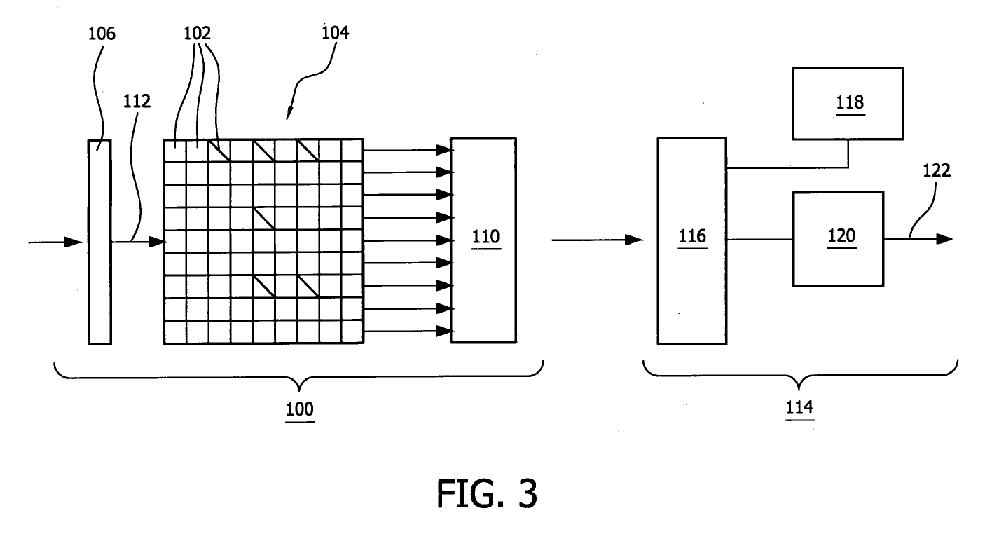

FIG. 3 is a schematic block diagram illustrating the principal components of a dosimeter system according to an exemplary embodiment of the present invention;

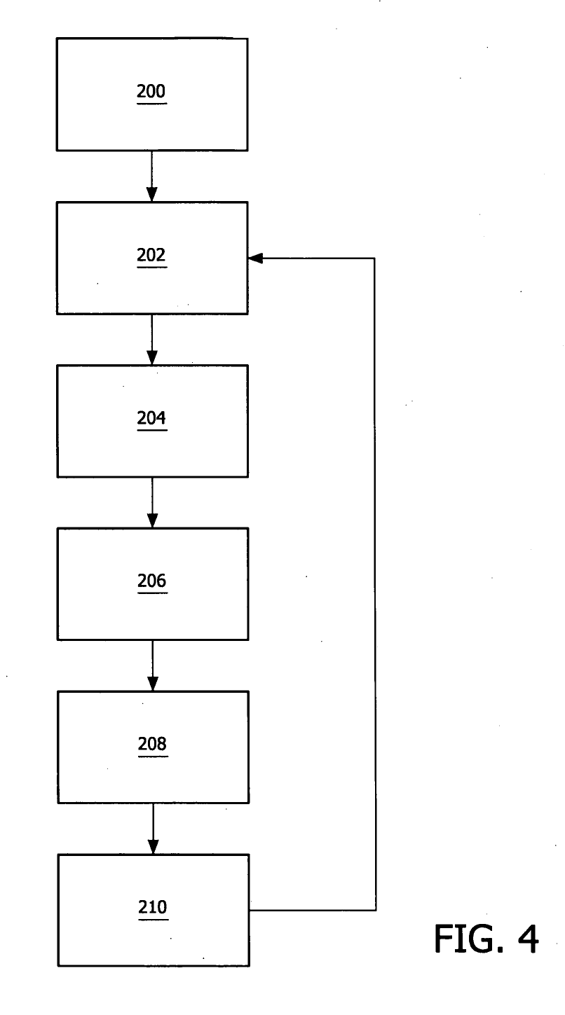

FIG. 4 is a schematic flow diagram illustrating the principal steps of a method of determining a level of radiation to which a user has been exposed according to an exemplary embodiment of the present invention; and

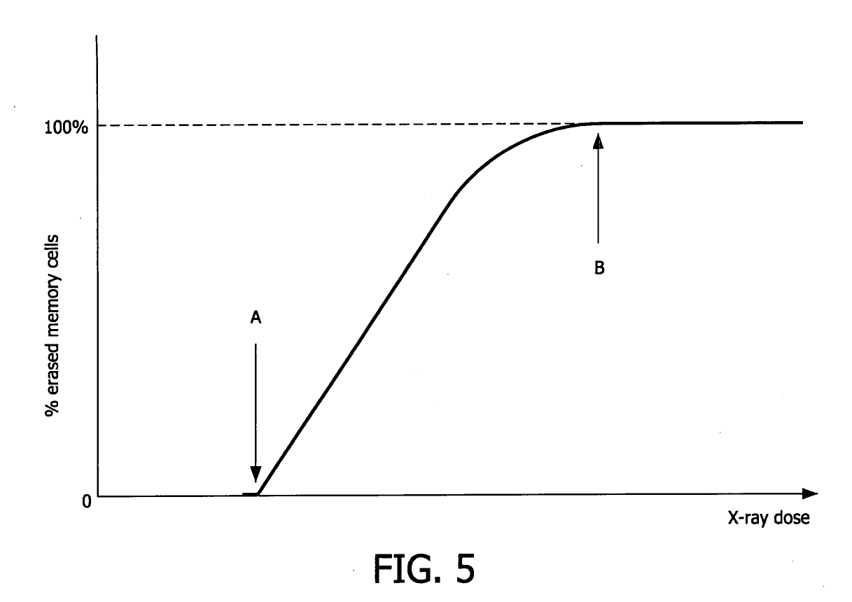

FIG. 5 is an illustrative sketch illustrating percentage of erased memory cells as a function of X-ray dose.

Referring to FIG. 1 of the drawings, in a conventional, p-channel Insulated Gate Field Effect Transistor (IGFET) structure, two p-type regions 10, 12 are diffused into an n-type substrate 14 to form a source (S) and drain (D). A layer 16 of insulating material (e.g. SiO₂) has been deposited, and a metallic gate 18 superimposed on this.

When the gate electrode of a conventional IGFET is modified to incorporate an additional metal-insulator ‘sandwich’ (a floating gate), the new structure can serve as a memory device in which semi-permanent charge storage is possible, without the need for a power supply (i.e. non-volatile memory). A schematic diagram of an IGFET with a floating gate is shown in FIG. 2, which is basically a p-channel enhancement-mode device. The structure of the gate electrode is layered like sandwich: insulator I(1), metal M(1), insulator I(2) and metal M(2).

In a floating gate transistor, charge is stored on the floating gate to change its threshold voltage, and when the charge is removed, the threshold voltage returns to its original value. Thus, the floating gate is used as a charge storing area, and by varying the amount of charge trapped on this gate, the threshold voltage of the device can be varied, thereby effectively creating a voltage level shift.

Referring to FIG. 3 of the drawings, an X-ray dosimeter detector device 100 according to an exemplary embodiment of the present invention comprises a plurality of non-volatile floating gate memory elements 102, arranged in an array 104 and preferably formed on a single integrated circuit die and housed within a package for attachment to, or incorporation in or on, a user's clothing or body. It will be appreciated that the area covered by the array 104 of non-volatile memory elements 102 will be dependent on the total radiation dose to which the user is expected to be exposed. A scintillator element 106 is provided which is arranged and configured between input radiation 108 and the memory array 104 (either partially or completely screening the memory array 104), to “capture” some of the X-radiation incident thereon and convert this to UV radiation. Provision of the scintillator element 106 means that the X-ray dose incident on the floating gate memory elements 102 is less, so that the floating gate volume can be reduced, thereby enabling the resultant detector to be smaller, less complex and less expensive to manufacture. The scintillator element 106 may comprise, for example, doped NaI or more advanced material, as will be apparent to a person skilled in the art, and may be of a significant thickness, say of the order of 1 cm, depending on the material used.

It will be appreciated that there are many different types of non-volatile floating gate memories known in the art, and the present invention is not intended to be limited in this regard. For example, flash memories may be used or SONOS (Semiconductor-Oxide-Nitride-Oxide-Semiconductor) memories, in which a charge can be trapped in the nitride layer of the gate structure.

An interface circuit 110 is also provided, to enable the detector 100 to interface with external reader devices, thereby minimising complexity of the detector unit (by eliminating the need for the reader functionality to be incorporated in the detector unit).

Referring additionally to FIG. 4 of the drawings, at step 200, the array 104 of non-volatile memories 102 is programmed so that all of the memory elements 102 have a charge on the floating gate. Programming a floating gate memory element can be defined as increasing the number of electrons trapped on the floating gate of the device, whereas deprogramming or erasing is the exact opposite operation. There are a number of methods in common use for performing both of these procedures. One such method, known as Fowler-Nordheim tunnelling, is accomplished by creating a powerful field across a gate oxide that enables electrons to tunnel through the oxide. The two key guidelines to this type of programming and erasing are ensuring the field strength is high enough to enable tunnelling, while maintaining low enough field strength to prevent oxide destruction, as will be well known to a person skilled in the art.

Another programming method is known as hot electron injection and involves placing a V_{DS} bias across the device as well as a V_{GS} bias. These conditions allow an electron travelling through the channel to tunnel through the gate oxide near the drain.

Other methods will be apparent to a person skilled in the art, and the present invention is not necessarily intended to be limited in this regard. Programming of the non-volatile memory elements may be performed using the reader device 114 (to be explained further hereinafter), but this is not essential. Separate means may be provided for this purpose.

At step 202, once programmed, the detector device 100 can be attached to a user's clothing, for example, as with conventional dosimeter devices. Alternatively, the detector device may be incorporated into a special package for incorporation into a user's clothing. In any event, it will be appreciated that no battery or other power supply is required.

As the user is exposed to X-radiation, X-rays 112 will penetrate the filter 106 to reach the non-volatile memory elements 102, causing the charge on some of the floating gates to be removed so as to cause a corresponding shift in threshold voltage in the respective memory elements 102. Only some of the floating gates are likely to be Vt-shifted with a given exposure time, because of the stochastic nature of the X-ray absorption process in the scintillator element 106 (which can also be referred to as the “absorbing converter” or “phosphor” material). As the energy of the incident X-rays becomes higher, the absorption length becomes larger, e.g. at 10 keV, the absorption length in, for example, Perspex or PMMA is about 10 mm. As a result, absorption “events” have to be treated as a stochastic process in the absorbing volume. Efficient scintillators generate many photons per absorbed X-ray, and have little self-absorption.

After some exposure time period, the detector 100 may be connected at step 204 to the reader 114, via interfaces 110 and 116. The reader 114 comprises a power supply 118 for supplying electrical power to read the number of devices 102 which have undergone a threshold voltage shift as a result of exposure to X-rays (step 206). In one exemplary embodiment, means may also be provided to measure the amount of the respective threshold voltage shifts as well, but this is not essential. Basically, the extent of threshold voltage shift can be measured by measuring a change in device current Ids with a given Vgs; and in floating gate devices, the charge on the floating gate is related to the change in threshold voltage by delta Vt=(t*Q)/ε, where Q is the charge on the floating gate, and t and ε are the gate oxide thickness and dielectric constant respectively. In principle, each device in the memory must be read out one-by-one, and the current amplified and compared to some voltage drop over some fixed resistor, say (in a very primitive version). However, the reading out of such non-volatile memory devices is standard in many embedded memory processes. Another method of reading out the chip is to make two identical chips, one of which is subject to x-rays and UV light, and the other one packaged in lead (thereby blocking all incident radiation), the latter chip thereby acting as a “control array”, and then the currents of the individual MOS transistors can be compared between the dosimeter chip and the shielded chip. In any event, it will be appreciated by a person skilled in the art that the process of reading out a non-volatile memory is relatively fast, i.e. of the order of <1 second for many mega-pixels.

Processing means 120 then employ predetermined, but universal, calibration curves to determine from the number of V_{T}-shifted memory elements 102, the total X-ray dose 122 to which the user has been exposed (step 208). The above-mentioned calibration curves are necessary to convert the number of erased memory cells to an X-ray exposure dose. Such curves depend at least on all of the following: scintillator material, scintillator volume, absorption properties of the detector package, coupling between UV light and floating gate, floating gate oxide thickness and permeability, gate length and width, supply voltage and density and size of “pixels (i.e. non-volatile memory elements). The curves may be determined by exposing the dosimeter device to a known dose of X-rays and measuring the number of erased cells as a function of dose, and a sketch of such a curve is provided in FIG. 5 as an example, which shows the threshold X-ray dose A (at which memory cells start to be erased) and the saturation dose at B (when all memory cells have been erased).

In addition, parts of the memory array 104 may be used to store data such as user information or time-stamps indicative of the last read-out operation performed in respect of the detector 100.

Finally, the detector array can be reset (at step 210) for subsequent re-use, by first erasing all of the non-volatile memory elements 102 of the array 104 (such that all electrons on the respective floating gates are removed) and then subsequently placing a charge on all of the floating gates, as before. This resetting process may again be performed by the reader 114.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A detector (100) for determining a level of radiation to which a user has been exposed, the device comprising a plurality of non-volatile memory elements (102), means (110) for enabling said memory elements (102) to be programmed by forming a charge at a floating gate thereof, means (110) for enabling the number of said memory elements which have undergone a shift in threshold voltage as a result of exposure to radiation (112) to be determined so as to enable determination therefrom the radiation dose (122) to which said user has been exposed.

2. A detector (100) according to claim 1, wherein said non-volatile memory elements (102) are provided in the form of an array (104).

3. A detector (100) according to claim 1, comprising a scintillator element (106) for converting a portion of high frequency radiation incident thereon to UV radiation.

4. A detector (100) according to claim l, further comprising a filter for permitting only radiation of a certain type, or radiation above a predetermined frequency, to reach said non-volatile memory elements (102).

5. A detector (100) according to claim 1, wherein a portion of said plurality of non-volatile memory elements (102) are used to store data, including user data in relation to a predetermined one or more users and/or time stamps indicative of one or more previously read-out operations.

6. A detector (100) according to claim 1, comprising an interface (110) for enabling a reader (114) to be coupled thereto, for hard-wired or wireless communication therewith.

7. A reader device (114) for use with the detector (100) according to claim 1, the reader device (114) comprising means (116) for connecting said reader device (114) to said detector (100) and receiving data therefrom representative of the number of memory elements (102) which have undergone a shift in threshold voltage as a result of exposure to radiation (112), comparing said data with predetermined calibration data and determining thereby a radiation dose (122) to which a user has been exposed.

8. A reader device (114) according to claim 7, further comprising means for programming the non-volatile memory elements (102).

9. A reader device (114) according to claim 7, arranged and configured to read data from said detector (100) representative of a number of memory elements (102) in respect of which the threshold voltage has been shifted as a result of exposure to radiation (112).

10. A reader device (114) according to claim 7, wherein the calibration data comprises predetermined calibration curves.

11. A dosimeter system comprising the detector (100) according to claim 1, and the reader device (114) according to claim 7.

12. An X-ray dosimeter system according to claim 11.

13. An X-ray dosimeter system according to claim 12, wherein said detector (100) comprises a scintillator element (106) for converting a portion of X-radiation incident thereon to UV radiation.

14. A method of determining a level of radiation to which a user has been exposed, the method comprising providing a user with a detector (100) according to claim 1, obtaining data therefrom representative of the number of memory elements (102) which have undergone a shift in threshold voltage as a result of exposure to radiation (112), comparing said data with predetermined calibration data and determining thereby a radiation dose (122) to which a user has been exposed.
